(19) United States
(12) Patent Application Publication
(10) Pub. No.: US 2008/0266208 A1
(43) Pub. Date: Oct. 30, 2008

(54) Image transmission control system, wrighting device, transmitter and computer readable medium

(75) Inventors: Yoshitsugu Hirose, Kanagawa (JP); Masao Watanabe, Kanagawa (JP); Takayuki Takeuchi, Kanagawa (JP); Hiroyuki Funo, Kanagawa (JP); Yoshiro Yamaguchi, Kanagawa (JP); Eriko Tamaru, Kanagawa (JP); Kimitake Hasuike, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/073,123

(22) Filed: Feb. 29, 2008

(30) Foreign Application Priority Data
Apr. 25, 2007 (JP) 2007-114975

(51) Int. Cl. G09G 3/00

(52) U.S. Cl. 345/30

(57) ABSTRACT

An image transmission control system includes: a displaying medium that forms an image so as to be rewritten in accordance with an external writing force and displays the formed image even after the external writing force is removed; a writing device including: a first communication unit that is adaptable to at least two kinds of communication systems selected from a wired communication system and a plural kinds of wireless communication systems having different communication distances; and a writing unit that applies the external writing force based on image information received by the first communication unit to the displaying unit to write the image; and a transmitter including: a second communication unit that is adaptable to the plural kinds of communication systems of the first communication unit; and a selecting unit that selects a communication system transmitting the image information to the writing device in accordance with information for instructing to transmit the image information.

### CROSS-REFERENCE TO RELATED APPLICATIONS

This application is based on and claims priority under 35 U.S.C. 119 from Japanese Patent Application No. 2007-114975 filed Apr. 25, 2007.

### BACKGROUND

1. Technical Field

The present invention relates to an image transmission control system, a writing device, a transmitter and a computer readable medium.

2. Related Art

A printed matter ordinarily serves to display a fixed image by externally supplying a coloring material or a developing material such as ink or toner to a medium such as paper. As a medium by which such a medium for fixedly displaying and holding the image can be replaced, a displaying and holding medium has been studied and developed on which an image is formed so as to be rewritten depending on an external wiring force and the formed image is displayed and held even after the external writing force is removed.

Such a displaying and holding medium includes a displaying material for forming the image in a display part as an area for displaying and holding the image. The external writing force (a chemical action such as electric, magnetic, heat, liquid of prescribed PH) is allowed to act on the displaying material, so that the state of the displaying material is physically or chemically changed to form the image corresponding to the external writing force. Further, even after the external writing force is removed, the formed image is maintained. Further, when a different external writing force is allowed to act on the image, the previous image is changed to an image corresponding to the new external writing force. As described above, in view of a point that a displayed state is maintained (stored) under a state that the external writing force is removed, the displaying and holding medium is similar to paper. In addition thereto, in view of a point that the displayed image can be rewritten without externally supplying the coloring material or a developer, the displaying and holding medium is similar to an electronic device. Thus, the displaying and holding medium is frequently referred to as electronic paper.

### SUMMARY

For instance, a system is proposed that image information of an electronic document is transmitted to a wiring device from an operating terminal of a portable telephone or a personal computer (PC) and the writing device writes and displays the image of the electronic document based on the image information on a displaying and holding medium.

Here, a user is ordinarily set who is permitted to read the electronic document for each electronic document to control an access. However, since there is a risk that during a process for transmitting the image information of the electronic document to the writing device from, for instance, a transmitter (the operating terminal) by a radio communication, the communication information is intercepted by other person, a countermeasure for ensuring a security is necessary between the transmitter and the wiring device.

The present invention is devised by considering the above-described usual circumstances and it is an object of the present invention to realize a security control between a transmitter and a writing device in a system that transmits image information from the transmitter to the writing device to write and display an image on a displaying and holding medium.

According to an aspect of the present invention, an image transmission control system including: a displaying medium that forms an image so as to be rewritten in accordance with an external writing force and displays the formed image even after the external writing force is removed; a writing device including: a first communication unit that is adaptable to at least two kinds of communication systems selected from a wired communication system and a plural kinds of wireless communication systems having different communication distances; and a writing unit that applies the external writing force based on image information received by the first communication unit to the displaying unit to write the image; and a transmitter including: a second communication unit that is adaptable to the plural kinds of communication systems selected from the first communication unit; and a selecting unit that selects a communication system transmitting the image information to the writing device in accordance with information for instructing to transmit the image information.

### BRIEF DESCRIPTION OF THE DRAWINGS

Exemplary embodiment of the present invention will be described in detail based on the following figures, wherein:

FIG. 1 is a diagram showing a functional structure of an image transmission control system according to one embodiment of the present invention;

FIG. 2 is a diagram showing a security managing table according to the one embodiment of the present invention;

FIGS. 3A to 3D are diagrams for explaining a communication system according to the one embodiment of the present invention;

FIG. 4 is a diagram for explaining a procedure of transmitting image information according to the one embodiment of the present invention;

FIG. 5 is a diagram for explaining a procedure of transmitting the image information according to the one embodiment of the present invention;

FIG. 6 is a diagram for explaining the structure of an optically rewrite type electronic paper;

FIG. 7 is a diagram for explaining an operational principle of the optically rewrite type electronic paper;

FIG. 8 is a diagram for explaining the structure of an electrically rewrite type electronic paper; and

FIG. 9 is a diagram for explaining an operational principle of the electrically rewrite type electronic paper.

### DETAILED DESCRIPTION

Initially, a displaying and holding medium (what is called, electronic paper) that can be used in the present invention will be described.

The electronic paper is a medium on which an image is formed so as to be rewritten in accordance with an external writing force and the formed image is displayed and held even after the external writing force is removed. As a display principle of the electronic paper, may be used display principles for driving elements in a manner like a chain reaction, for instance, a display principle that an external force such as an electric force, a magnetic force, a thermal force, etc. is directly applied to drive the elements, a display principle that the elements are driven by a voltage change due to an irradiation of light, a display principle that a colored state is changed by the change of PH of liquid due to an application of voltage.

As one example of the electronic paper, the electronic paper that rewrites an image by applying light (refer it to as an optically rewrite type electronic paper, hereinafter) will be specifically described below.

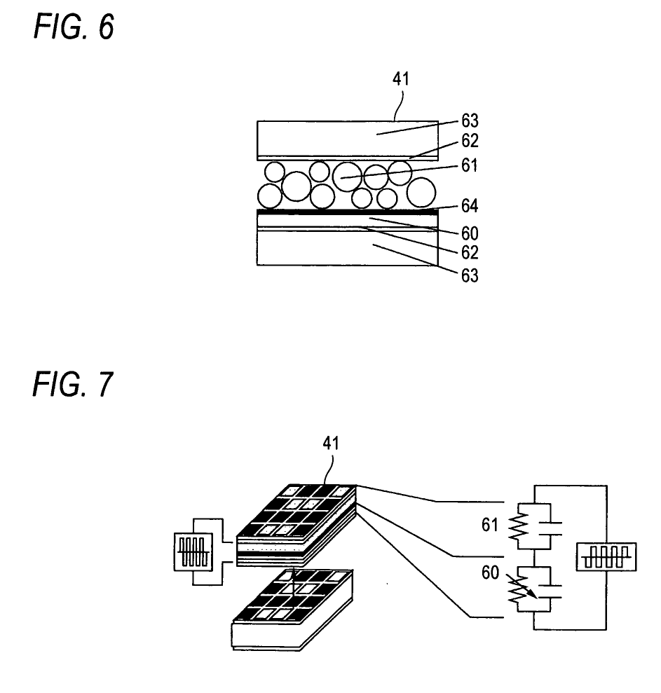

The optically rewrite type electronic paper includes, as illustrated in FIG. 6 showing a sectional structure of a display part 41 that occupies a substantial part of the medium, a layer of an organic photo-conductive material (an organic photo-conductive layer) 60 used for a copying machine and a layer of a liquid crystal display material(a micro-capsulated cholesteric liquid crystal layer) 61 that are combined together, a pair of front and back transparent electrodes 62 that sandwich these layers in between them and a pair of front and back transparent base material films 63 that sandwich this laminated body in between them. In this structure, the cholesteric liquid crystal layer 61 can realize a white color display that reflects light and a monochromatic image of a black color display obtained by allowing the light to be transmitted to the liquid crystal layer 61 and absorbed by a black layer 64 provided between the cholesteric liquid crystal layer 61 and the organic photo-conductive layer 60. Further, a cholesteric liquid crystal has a feature of interfering with and reflecting a color light corresponding to a spiral pitch. Thus, the cholesteric liquid crystal layer 61 is formed by laminating liquid crystals having different spiral pitches, so that a color display can be realized by a simple structure.

Then, as illustrated in FIG. 7 showing an operational principle of the display part 41, in the optically rewrite type electronic paper, when an image transferred to, for instance, a light adjusting element panel (a light emitting panel) for writing an image is displayed and projected on the display part 41 and a voltage is applied to a writing electrode provided in the display part 41, the display part 41 instantaneously converts the strength and weakness of the light into a reflection density and holds the projected image. Then, an erasing voltage is applied to the electrode so that image information held by the display part 41 can be erased. The optically rewrite type electronic paper can be reused many times by repeating a writing process and an erasing process. In the optically rewrite type electronic paper, the voltage is applied to the electrode as described above without carrying out such an erasing process to project a new image on the display part, so that the image can be overwritten on the image information held by the display part 41. The optically rewrite type electronic paper can be also reused many times by such an overwriting process.

As another example of the electronic paper, an electronic paper (refer it to as an electrically rewrite type electronic paper, hereinafter) will be specifically described in which an electric power is directly applied to rewrite an image.

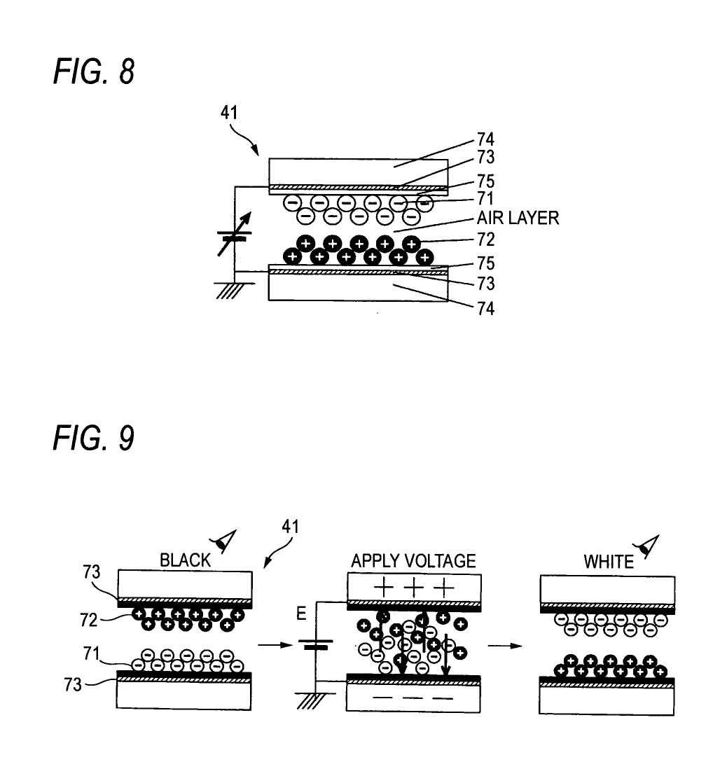

The electrically rewrite type electronic paper includes, as illustrated in FIG. 8 showing a sectional structure of a display part 41 that occupies a substantial part of a medium, fine colored and charged particles (in an illustrated example, white particles 71 and black particles 72) sealed between a pair of front and back electrodes 73 having at least a transparent front side and a pair of front and back film base plates 74 having at least a transparent front side that sandwich the electrodes 73 in between them. An air layer is provided between the electrode layers 73 so that the colored particles 71 and 72 can freely move. Further, in the matrix shaped electrode layers 73, insulating layers 75 are provided to prevent the colored particles 71 and 72 from coming into contact with the electrode layers. A color filter may be used to realize a color display by a simple structure.

As illustrated in FIG. 9 showing an operational principle of the display part 41, in the electrically rewrite type electronic paper, under a state that a voltage is not applied to the electrode 73 (in this case, the electrode 73 is charged to a polarity during a driving operation of the last time), the white particles 71 charged to a minus are accumulated on a back surface side. On the other hand, the black particles 72 charged to a plus are accumulated on the front surface side. Thus, when the display part 41 is visually observed from the front surface side, the display part 41 is in a state of a black color. Then, when a driver (a below-described writing part 32) connected to the electrically rewrite type electronic paper is operated in accordance with image data to invert the polarity of the electrode of a prescribed part of a matrix of the display part 41 corresponding to an image to be displayed by the function of the driver, a positional relation of the white particles 71 and the black particles 72 is changed so that an image by the contrast between the white particles 71 and the black particles 72 is displayed on the display part 41. When the driver is operated in accordance with different image data, an image displayed on the display part 41 can be switched by the contrast between the white particles 71 and the black particles 72 and the electrically rewrite type electronic paper can be reused many times.

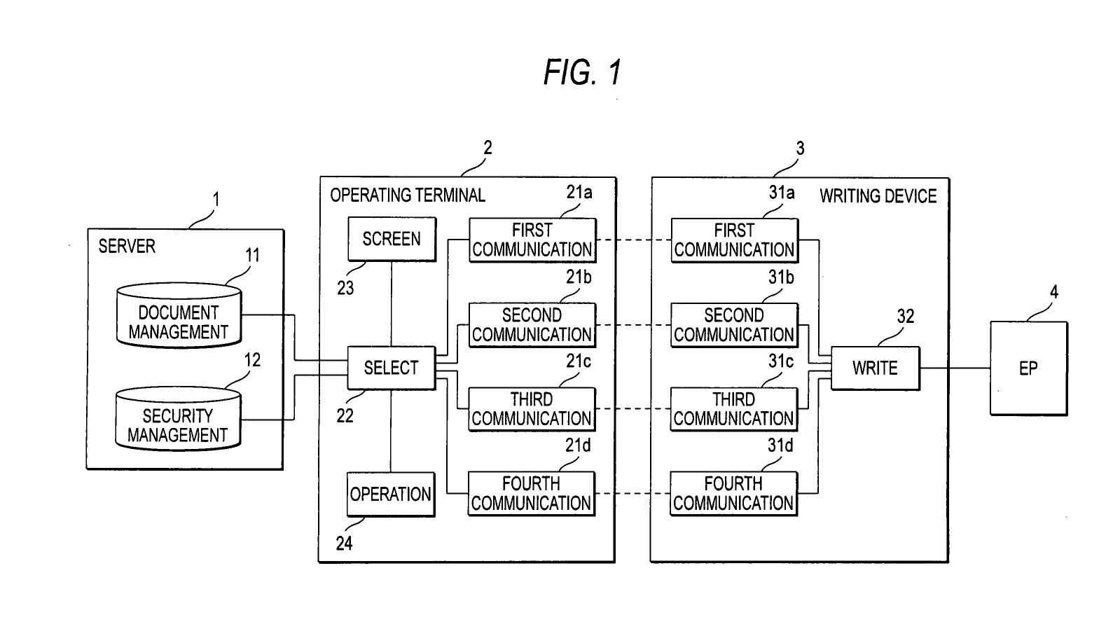

FIG. 1 shows the structure of an image transmission control system according one embodiment of the present invention. The image transmission control system of this embodiment includes a server device 1, an operating terminal 2, a writing device 3 and an electronic paper 4. The operating terminal 2 and the writing device is adaptable to plural kinds of communication systems and switch the communication systems depending on situations as described below.

The server device 1 includes a document managing table 11 for holding and managing an electronic document and a security managing table 12 for holding and managing security information.

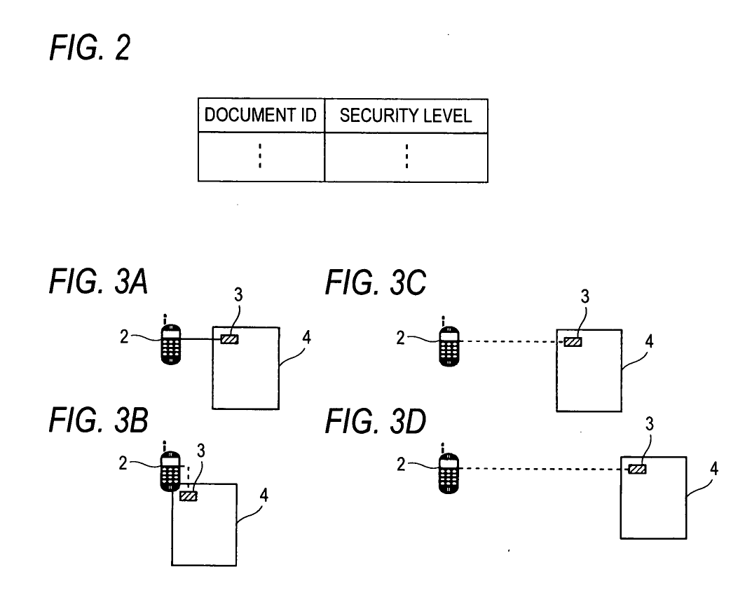

The security managing table 12 of this embodiment includes, as shown in FIG. 2, holds a set of a “document ID” for identifying each electronic document and a “security level” showing the communication system used for transmitting the image information of the electronic document to the writing device 3 from the operating terminal 2. That is, usable communication systems are set respectively for the electronic documents.

The operating terminal 2 includes a plurality of communication parts 21 provided respectively for the communication systems, a selecting part 22 for selecting the communication system used for transmitting the image information, a screen 23 for displaying the information of the selected communication system and an operating part 24 for receiving an input of an instruction from a user.

In this embodiment, a portable telephone is used as the operating terminal 2, however, other portable device such as a PDA (Personal Digital Assistants) or a stationary device such as a desk top personal computer may be used. Further, in this embodiment, a transmitting port device (refer it to as a “port”, hereinafter) externally connected to the operating terminal 2 is provided with the communication parts 21 and the selecting part 22, however, they may be provided in the operating terminal 2.

The writing device 3 includes a plurality of communication parts 31 provided respectively for the communication systems and a writing part 32 for writing an image on the electronic paper 4 in accordance with the received image information.

In this embodiment, the electrically rewrite type electronic paper is used as the electronic paper 4. The writing part 32 changes the polarity of the electrode in the prescribed part of the matrix shaped electrode provided on the display part 41 of the electronic paper 4 to write and display the image on the display part 41. For instance, when an optically write type electronic paper is used, the writing part 32 may be formed to carry out a writing process in accordance with the display principle of the electronic paper in such a way that the writing part 32 may be formed with a functional part such as a light emitting panel necessary for optically writing an image to project and write the image on the display part 41.

In this embodiment, the writing device 3 is formed as an adapter device (refer it to as an “adapter”, hereinafter) detachably connected to the electronic paper 4, however, they may be formed integrally to form a self-rewrite type electronic paper.

The image transmission control system of this embodiment includes a wired communication system (a first communication system) realized by directly connecting the operating terminal (port) 2 to the writing device (adapter) 3 or indirectly connecting the operating terminal to the writing device by a cable as shown in FIG. 3(a), a radio communication system (a second communication system) in a near distance (for instance, 1 cm) as shown in FIG. 3(b), a radio communication system (a third communication system) in an intermediate distance (for instance, 30 cm) as shown in FIG. 3(c) and a radio communication system (a fourth communication system) in a remote distance (for instance, 10 m) as shown in FIG. 3(d).

Then, the operating terminal 2 and the writing device 3 include first communication parts 21a and 31a being adaptable to the first communication system, second communication parts 21b and 31b being adaptable to the second communication system, third communication parts 21c and 31c being adaptable to the third communication system and fourth communication parts 21d and 31d being adaptable to the fourth communication system.

The image transmission control system is not limited to the above-described structure(the structure having one wired communication system and three radio communication systems) and, for instance, other structures such as a structure having one wired communication system and one radio communication system, a structure having a plural kinds of wireless communication systems (having no wired communication system) or the like may be employed.

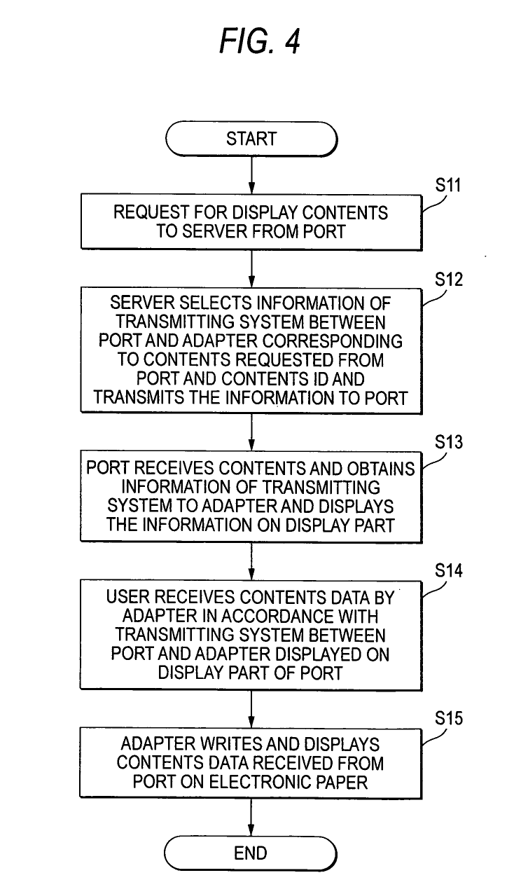

A procedure of transmitting the image information by the image transmission control system of this embodiment will be described by referring to FIG. 4.

When the user selects contents (the electronic document) to be displayed by operating the operating part 24 of the operating terminal 2, the operating terminal 2 transmits a contents ID (the document ID of the electronic document) to the server device 1 to request for contents information (the image information of the electronic document) (step S11).

The server device 1 specifies the contents information (the image information) corresponding to the contents ID (the document ID) by referring to the document managing table 11 and specifies the information of the communication system between the port and the adapter corresponding to the contents ID (the document ID) by referring to the security managing table 12 to transmit the information to the port (the operating terminal 2) (step S12).

When the port (the operating terminal 2) receives the contents information (the image information) and the information of the communication system, the operating terminal 2 displays and outputs the communication system on the screen 23 to inform the user of the communication system (step S13). The communication system may be outputted and reported by sound by a speaker.

The user operates the adapter (the writing device 3) in accordance with the reported communication system (in the case of the wired communication system, the adapter is connected to the port, and in the case of the radio communication system, the adapter is arranged in a position corresponding to a communication distance thereof) to transmit the image information from the port (the operating terminal 2) to the adapter (the writing device 3) in accordance with the communication system (step S14).

The adapter (the writing device 3) writes and displays the image based on the received image information on the electronic paper 4 by the writing part 32 (step S15).

As described above, in this embodiment, the communication system between a transmitter 2 and the writing device 3 is switched in accordance with the security level of the electronic document to realize a security control in communication between these devices.

The security control may be also carried out in accordance with a user who instructs to transmit the image information, a place where the image information is instructed to be transmitted, a data on which the image information is instructed to be transmitted, the writing device 3 to which the image information instructed to be transmitted is transmitted and the electronic paper 4 on which the image based on the image information instructed to be transmitted is written as well as the security control in accordance with the electronic document (the image information) instructed to be transmitted as described above.

When the security control is carried out in accordance with the user who instructs to transmit the image information, the usable communication systems may be set respectively for users in the security managing table 12 to specify the user who instructs to transmit the image information and select the communication system.

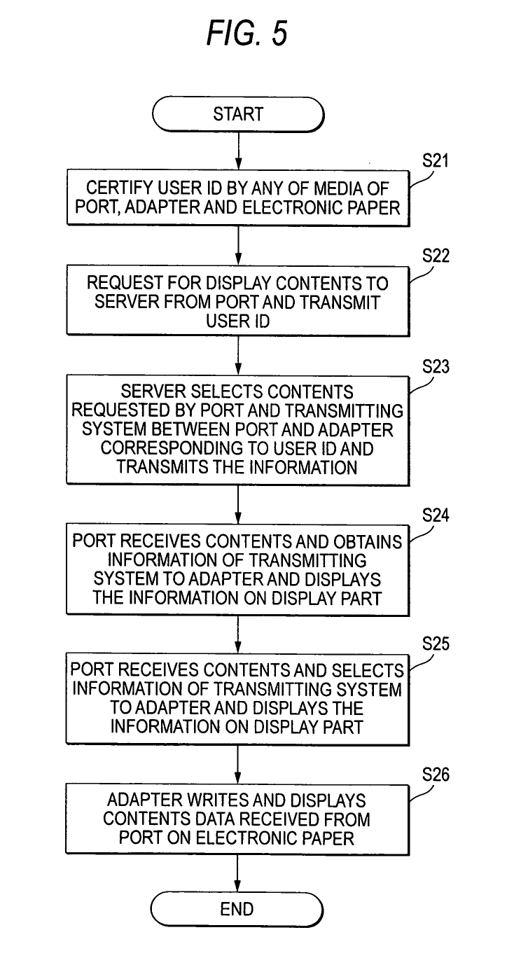

Namely, as shown in FIG. 5, as a precondition for using this system, a user ID and a password for certifying the user are initially received from the user to certify the user (step S21). In this embodiment, the operating terminal 2 certifies the user, however, the writing device 3 or the electronic paper 4 may certify the user. Further, the user may be certified (biological certification) on the basis of a biological feature peculiar to the user such as a finger print. Further, the user ID may be previously stored in any of the operating terminal 2, the writing device 3 and the electronic paper 4 to omit a user certifying process.

After that, when the contents (the electronic document) to be displayed are selected by the user, the contents ID (the document ID of the electronic document) and the user ID are transmitted to the server device 1 (step S22).

The server device 1 specifies the contents information (the image information) corresponding to the contents ID (the document ID) by referring to the document managing table 11, specifies the information of the communication system between the port and the adapter corresponding to the user ID by referring to the security managing table 12 and transmits the information to the port (the operating terminal 2) (step S23).

When the port (the operating terminal 2) receives the contents information (the image information) and the information of the communication system, the port displays and outputs the communication system on the screen 23 to inform the user of the information (step S24).

The user operates the adapter (the writing device 3) in accordance with the reported communication system to transmit the image information from the port (the operating terminal 2) to the adapter (the writing device 3) in accordance with the communication system (step S25).

The adapter (the writing device 3) writes and displays the image based on the received image information on the electronic paper 4 by the writing part 32 (step S26).

When the security control is carried out in accordance with the place where the image information is instructed to be transmitted, the usable communication systems may be set respectively for places in the security managing table 12 to specify the place where the image information is instructed to be transmitted and select the communication system.

As a method for specifying the place, for instance, devices for transmitting place IDs for respectively identifying places may be provided in the places to specify the place by receiving the place ID by the operating terminal 2 or a GPS (Global Positioning System) may be used to specify the place or the place may be specified by the place ID inputted by operating the operating terminal 2 by the user.

When the security control is carried out in accordance with the date on which the image information is instructed to be transmitted, the usable communication systems may be set respectively for dates in the security managing table 12 to specify the date on which the image information is instructed to be transmitted and select the communication system.

When the security control is carried out in accordance with the writing device 3 to which the image information instructed to be transmitted is transmitted, the usable communication systems may be set respectively for writing devices in the security managing table 12 to specify the writing device 3 to which the image information instructed to be transmitted is transmitted and select the communication system.

As a method for specifying the writing device 3, for instance, a device ID for identifying each writing device 3 previously stored in the writing device 3 may be read to specify the writing device 3 or the writing device 3 may be specified by the device ID inputted by operating the operating terminal 2 by the user.

When the security control is carried out in accordance with the electronic paper 4 on which the image based on the information instructed to be transmitted is written, the usable communication systems may be set respectively for electronic paper in the security managing table 12 to specify the electronic paper 4 on which the image based on the image information instructed to be transmitted is written and select the communication system.

As a method for specifying the electronic paper 4, for instance, a medium ID for identifying each electronic paper 4 previously stored in the electronic paper 4 may be read to specify the electronic paper 4 or the electronic paper 4 may be specified by the medium ID inputted by operating the operating terminal 2 by the user.

For instance, at least two kinds of the communication systems for the electronic documents, the communication systems for the users, the communication systems for the places, the communication systems for the dates, the communication systems for the writing devices and the communication systems for the electronic paper may be set in the security managing table to select the communication system by collectively deciding a situation or an environment where the image information is instructed to be transmitted.

Here, the transmitter 2 and the writing device 3 of this embodiment are realized by executing a program according to the present invention by a computer having resources of hardware of a calculating part such as a CPU (Central Processing Unit) or a storing part such as a RAM (Random Access Memory).

Specifically, the program according to the present invention is previously stored and held in a ROM (Read Only Memory) provided in the computer. The program is read, developed in the storing part and executed by the calculating part to realize function units according to the present invention.

For instance, a medium connecting part such as a slot for loading an external storing medium such as a CD-ROM (Compact Disc Read Only Memory) or a memory cartridge may be provided in the computer to read the program by the medium connecting part from the external storing medium that stores and holds the program according to the present invention so as to be read by the computer and execute the program. Further, for instance, a communication part may be provided in the computer for communicating with a server device having a function for transmitting the program according to the present invention through a network to receive the program from the server device by the communication part and execute the program. Further, the program according to the present invention externally obtained as described above may be stored and held in an HDD (Hard Disk Drive) of the computer to read and execute the program from the HDD.

The function units of the present invention may be formed not by a software structure as described above, but by an exclusive hardware circuit.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An image transmission control system comprising:
a displaying medium that forms an image so as to be rewritten in accordance with an external writing force and displays the formed image even after the external writing force is removed;
a writing device including:
a first communication unit that is adaptable to at least two kinds of communication systems selected from a wired communication system and plural kinds of wireless communication systems having different communication distances; and
a writing unit that applies the external writing force based on image information received by the first communication unit to the displaying unit to write the image; and
a transmitter including:
a second communication unit that adaptable to the plural kinds of communication systems to which the first communication unit is adaptable; and
a selecting unit that selects a communication system transmitting the image information to the writing device in accordance with information for instructing to transmit the image information.

2. The image transmission control system as claimed in claim 1, wherein the selecting unit selects the communication system in accordance with the image information instructed to be transmitted.

3. The image transmission control system as claimed in claim 1, wherein the selecting unit selects the communication system in accordance with a user who instructs to transmit the image information.

4. The image transmission control system as claimed in claim 1, wherein the selecting unit selects the communication system in accordance with a place where the image information is instructed to be transmitted.

5. The image transmission control system as claimed in claim 1, wherein the selecting unit selects the communication system in accordance with a date on which the image information is instructed to be transmitted.

6. The image transmission control system as claimed in claim 1, wherein the selecting unit selects the communication system in accordance with the writing device to which the image information instructed to be transmitted is transmitted.

7. The image transmission control system as claimed in claim 1, wherein the selecting unit selects the communication system in accordance with the displaying medium on which the image based on the image information instructed to be transmitted is written.

8. A writing device comprising:
a communication unit that adaptable to at least two kinds of communication systems selected from a wired communication system and a plural kinds of wireless communication systems having different communication distances; and
a writing unit that applies, to a displaying medium on which an image is formed so as to be rewritten in accordance with an external writing force and the formed image is displayed even after the external writing force is removed, the external writing force based on image information received from a transmitter transmitting the image information by using a communication system corresponding to the communication system of the communication unit and selected in accordance with information related to an instruction to transmit the image information in order to write the image on the displaying medium.

9. A transmitter comprising:
a communication unit that is adaptable to at least two kinds of communication systems selected from a wired communication system and a plural kinds of wireless communication systems having different communication distances; and
a selecting unit that selects a communication system transmitting image information in accordance with information for instructing to transmit the image information, in a case where the image information is transmitted to a writing device that writes an image by applying an external writing force based on the image information received by the communication systems corresponding to the communication unit and received by any of the communication systems to a displaying medium in order to write the image on the displaying medium on which the image is formed so as to be rewritten in accordance with the external writing force and the formed image is displayed even after the external writing force is removed.

10. A computer readable medium storing a program causing a computer to execute a process for performing a security control between a transmitter transmitting the image information and a writing device in a system that transmits image information from the transmitter to the writing device to write and display an image on a displaying medium on which an image is formed so as to be rewritten in accordance with an external writing force and the formed image is displayed even after the external writing force is removed, the process comprising:
applying, to a displaying medium, the external writing force based on the image information received from the transmitter by using communication systems selected in accordance with information related to an instruction to transmit the image information in order to write the image on the displaying medium, the communication systems including at least two kinds of communication systems selected from a wired communication system and a plural kinds of wireless communication systems having different communication distances.

11. A computer readable medium storing a program causing a computer to execute a process for performing a security control between a transmitter transmitting the image information and a writing device in a system that transmits image information from the transmitter to the writing device to write and display an image on a displaying medium on which an image is formed so as to be rewritten in accordance with an external writing force and the formed image is displayed even after the external writing force is removed, the process comprising:
selecting communication system that transmits image information in accordance with information for instructing to transmit the image information, in a case where the image information is transmitted to a writing device that writes an image by applying the external writing force based on the image information received by communication systems corresponding to the communication unit and received by any of the communication systems to the displaying medium in order to write the image on the displaying medium, the communication systems including at least two kinds of communication systems selected from a wired communication system and a plural kinds of wireless communication systems having different communication distances.
